(19) United States
(12) Patent Application Publication
(10) Pub. No.: US 2024/0060769 A1
(43) Pub. Date: Feb. 22, 2024

(54) Method for Determining the Deformation of Structural Elements of a Delta Robot

(71) Applicant: OOO “MOLODAYA, DINAMICHNO RAZVIVAUSHCHAYASYA KOMPANIYA”, Moscow (RU)

(72) Inventor: Aleksandr Olegovich NEVOLIN, Moscow (RU)

(21) Appl. No.: 18/268,275

(22) PCT Filed: Dec. 2, 2021
(86) PCT No.: PCT/RU2021/050409

§ 371 Date: Jun. 19, 2023

(30) Foreign Application Priority Data
Dec. 17, 2020 (AU) 2020141901

(51) Int. Cl. G01B 11/16; B25J 19/02

(52) U.S. Cl. CPC G01B 11/16; B25J 19/022

(57) ABSTRACT

The preferred embodiments relate to the field of measuring technology, in particular, to instruments for measuring in-motion only deformations of elements in the structure of devices, preferably a delta robot. A method for determining the in-motion only deformations of the delta robot arm includes using a laser light source mounted on one side of the arm, a grid of photodiodes is mounted on the other side of the arm, and the laser light source and the grid of photodiodes are mounted so that in the absence of deformation of the arm, the laser light source is aimed precisely at the center of the grid of photodiodes, after which the delta robot is engaged in motion, during which the location of the laser light source relative to the center of the grid of photodiodes is determined. The invention increases the efficiency and reduces operating costs when determining in-motion deformations of the robot arm.

### BACKGROUND OF THE INVENTION

### Field of the Invention

The invention relates to the field of measuring technology, in particular, to instruments for measuring in-motion only deformations of elements in the structure of devices, preferably a delta robot.

### Description of Related Art

The prior art discloses a device for measuring structural deformation, which comprises a channel, a transmitter connected to the first end of the channel, a receiver connected to the second end of the channel, and a controller. The channel is deformable, the controller orders the transmitter to transmit a signal, orders the receiver to capture one or more measurements of the transmitted signal, and determines the channel bend based on the one or more measurements. In one embodiment, the transmitter is a light source, the channel is an optical fiber, and the receiver is a photodiode. In addition, the channel is made of a material whose refractive index changes depending on the applied mechanical stress. The deformation measurement device may also include a polarizer located between the transmitter and the channel, and a wave plate located between the channel and the receiver (U.S. Ser. No. 10/429,210 B1, Oct. 1, 2019).

The prior art discloses a technical solution, whereby the device provides a system for detecting the object deformation based on laser measurements. The deformation detection system comprises a laser radiation unit, a light uniformization unit, a light filtering unit, a light condensation unit, a photoelectric conversion unit, a signal conversion unit, a signal analysis and processing unit, a storage unit, a display unit, and an input unit. The deformation detection system projects a light stripe at a position perpendicular to the contour of the measured object. The photoelectric conversion unit is used to receive the light stripe, so that one part of the light of the light stripe is blocked by the measured object, the other part of the light is projected onto the photoelectric conversion unit, an electrical signal is fed, then the deformation of the measured object is calculated according to the change in the electrical signal, and then stored and displayed. The technical solution provides a laser measurement-based object deformation detection system, which improves the accuracy and efficiency of anti-interference when measuring object deformation (CN 209147939 U, Jul. 23, 2019).

A device for measuring displacement, deformation and/or deformation force of a mechanical component is the closest to the presented technical solutions. The device comprises means of emitting and receiving a light beam, and the aforesaid means are mechanically combined with a common base. Optical transmission means which intercept the light beam maintaining its transmission are also provided (FR 2599138 A1, Nov. 27, 1987).

### SUMMARY OF THE INVENTION

The main deficiency of these technical solutions is the complexity of their implementation, due to the need to use complex and expensive equipment.

The task to be solved by the present invention is the development and creation of a highly efficient and publicly available method for determining the in-motion only deformations of the structural elements of a delta robot, which would eliminate the aforesaid deficiencies.

The technical result of the claimed invention is to increase efficiency and reduce operating costs when determining the in-motion deformations of the delta robot arm.

To accomplish this technical result, a method is proposed for determining in-motion deformations of the delta robot arm, wherein a laser light source is first mounted on one side of the arm, a grid of photodiodes is mounted on the other side of the arm, and the laser light source and the grid of photodiodes are mounted so that in the absence of deformation of the arm, the laser light source is aimed precisely at the center of the grid of photodiodes, after which the delta robot is engaged in motion, during which specifically the location of the laser light source relative to the center of the grid of photodiodes is determined, if a displacement of the laser light source relative to the center of the grid of photodiodes is detected, a conclusion is made about any existing deformation of the arm.

The method implementation may include the use of a grid of photodiodes consisting of 4 segments.

An arm can be used as a structural element in the method implementation.

These and other features and advantages of the invention will become apparent to those skilled in the art from the following description and the accompanying drawing. It should be understood, however, that the detailed description and specific examples, while indicating a preferred embodiment of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 shows a schematic representation of a device designed to implement the presented method for determining in-motion only deformations of the structural elements of the delta robot.

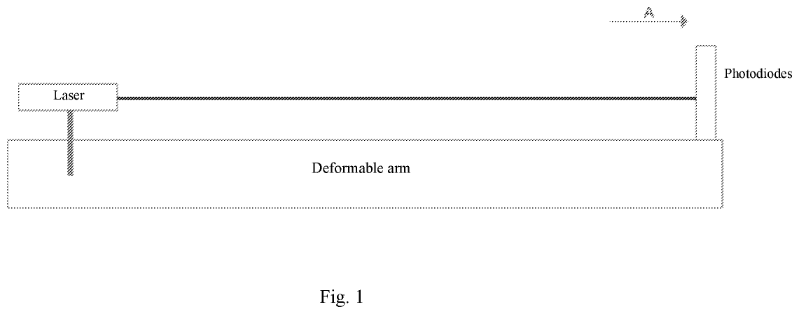

### DETAILED DESCRIPTION OF THE PREFERRED EMBODIMENTS

The implementation of this method for determining the in-motion only deformation of the delta robot structural elements will be considered using the example of the deformation of the upper and lower arms of the delta robot.

The delta robot is a high-speed piece of equipment that moves using a carriage. Moreover, accelerations on the carriage can reach 15 g, i.e., during the motion of the delta robot, its arms (both upper and lower) are exposed to significant loads, which result in their deformation. In this regard, this deformation needs to be promptly detected, since any existing deformation of the arms affects the pose accuracy, since slightly bent arm changes the geometry of the delta robot, and the position of the carriage will differ from the computed position.

First, a laser light source is attached to the upper arm on one side, i.e. beam-point, on the other side of the arm, a grid of photodiodes is mounted, preferably consisting of 4 identical segments. The laser light source and the grid of photodiodes are mounted in such a way that, in the absence of deformation of the arm, the beam-point aims precisely at the center of the grid of photodiodes. The beam-point by hitting all four (4) sectors of the photodiode produces the same signal on them (the same output voltage).

After the required equipment is mounted, for example, on the upper arm of the delta robot, it is set in motion. Specifically during the motion the location of the beam-point is determined relative to the center of the grid of photodiodes. If, for example, during the motion, the photodiode matrix shifts down relative to the beam, and the spot from the laser is higher than the starting point, the arm is then bent downwards.

The proposed method enables to record signals of any frequency and requires no additional calculations.

Next, a specific example of the method is given. In this regard, this example is given only as one of the embodiments of the proposed method and cannot be considered the only possible embodiment.

Assume that at the maximum acceleration of the robot, the arm is exposed to a bending force of about 50 N (if 3 arms carry a load of 1 kg with an acceleration of 15 g, this is 150 N in total, since there are 3 arms, it gives 50 N per arm).

Static tests show that exposure to this force can flex the arm up to 5 mm.

If the deviation is 5 mm, a method resolution of 0.5 mm is sufficient.

Next, the area of the photodiode is calculated.

The measurement error of the LED signal is set to 10%.

The required measurement accuracy or resolution is 0.5 mm. The typical laser beam diameter is 3 mm. This means that with a shift of 0.5 mm there should be a significant change in the signal from the photodiode. Accordingly, the increase in the area of the illuminated section should be more than 10% of the total area of the photodiode (due to the measurement error).

Next, calculations should be made of how the area of the illuminated section will change when the beam is shifted by 0.5 mm.

For which purpose, the following formula is used: D*delta/2, where
D is beam diameter, mm
Delta is shift, mm.

Accordingly, a shift of 0.5 mm gives: 3*0.5/2=0.75 mm².

Accordingly, the photodiode area should be 0.75*10=7.5 mm², which corresponds to a 2.7 mm square.

All of the above confirms that this invention provides a highly efficient, publicly available method for determining in-motion only deformations of structural elements of a delta robot, which does not involve the use of complex and expensive equipment to implement it, i.e. an increase in efficiency and a decrease in operating costs are accomplished in the process of determining the in-motion deformation of the delta robot arm.

1. A method for determining in-motion only deformations of a delta robot arm, the method comprising:
mounting a laser light source on one side of the delta robot arm, a grid of photodiodes is mounted on the other side of the delta robot arm, wherein the laser light source and the grid of photodiodes are mounted so that in the absence of deformation of the robot arm, the laser light source is aimed at the center of the grid of photodiodes;
moving, thereafter, the delta robot,
determining the location of the laser light source relative to the center of the grid of photodiodes and
wherein if a displacement of the laser light source relative to the center of the grid of photodiodes is detected, deformation of the lever is determined.

2. The method of claim 1, wherein a resolution of the deformation is less than 1 mm.

3. The method of claim 2, wherein the resolution is about 0.5 mm.

4. The method of claim 3, wherein an area of the grid of photodiodes is at least 2.5 mm.

5. The method of claim 4, wherein an acceleration of the delta robot arm is at least 10 g.
